(19) United States
(12) Patent Application Publication
(10) Pub. No.: US 2017/0249067 A1
(43) Pub. Date: Aug. 31, 2017

(54) USER INTERFACE FEATURE RECOMMENDATION

(71) Applicant: International Business Machines Corporation, Armonk, NY (US)

(72) Inventors: Rex E. Marzke, Houston, TX (US); Vinod A. Valecha, Pune (IN)

(21) Appl. No.: 15/055,955

(22) Filed: Feb. 29, 2016

(51) Int. Cl. G06F 3/0484; G06F 17/30; G06F 3/0488

(52) U.S. Cl. CPC G06F 3/0484; G06F 3/04886; G06F 17/30528

(57) ABSTRACT

A computer-implemented method includes receiving a usage pattern. The usage pattern is associated with a mobile device. The method includes identifying one or more user interface features. The one or more user interface features are for the mobile device. The one or more user interface features are at most included below a threshold extent in the usage pattern. The method includes analyzing the usage pattern to yield potential user interface features. The method includes comparing the usage pattern user interface features to the one or more user interface features. The method is responsive to at least one of the one or more user interface features corresponding to any of the potential user interface features. The method includes indicating at least one of the one or more user interface features.

### BACKGROUND

The present invention relates generally to the field of mobile device features and more particularly to user interface features.

User interface is the space where interactions between users and machines occur. A mobile device user interface feature allows a user to control and utilize the mobile device. A mobile device may include several user interface features to accomplish the same goal. For example, a phone may have a physical button such that a user may turn the mobile device on and off and the mobile device may respond to a voice command to turn the phone on and off. Programmers and mobile device users continue to face struggles learning and using mobile device features.

### SUMMARY

A computer-implemented method includes receiving a usage pattern. The usage pattern is associated with a mobile device. The method includes identifying one or more user interface features. The one or more user interface features are for the mobile device. The one or more user interface features are at most included below a threshold extent in the usage pattern. The method includes analyzing the usage pattern to yield potential user interface features. The method includes comparing the usage pattern user interface features to the one or more user interface features. The method is responsive to at least one of the one or more user interface features corresponding to any of the potential user interface features. The method includes indicating at least one of the one or more user interface features.

### BRIEF DESCRIPTION OF THE DRAWINGS

FIG. 1 is a block diagram of an operational environment suitable for operation of a user interface recommendation program in accordance with at least one embodiment of the present invention.

FIG. 2 is a flowchart depicting operational steps for a user interface recommendation program in accordance with at least one embodiment of the present invention.

FIG. 3 is a flowchart depicting operational steps for a user interface recommendation program in accordance with at least one embodiment of the present invention where the user interface recommendation program creates a user profile.

FIG. 4 is a block diagram of components of a computing apparatus suitable for executing a user interface recommendation program in accordance with at least one embodiment of the present invention.

### DETAILED DESCRIPTION

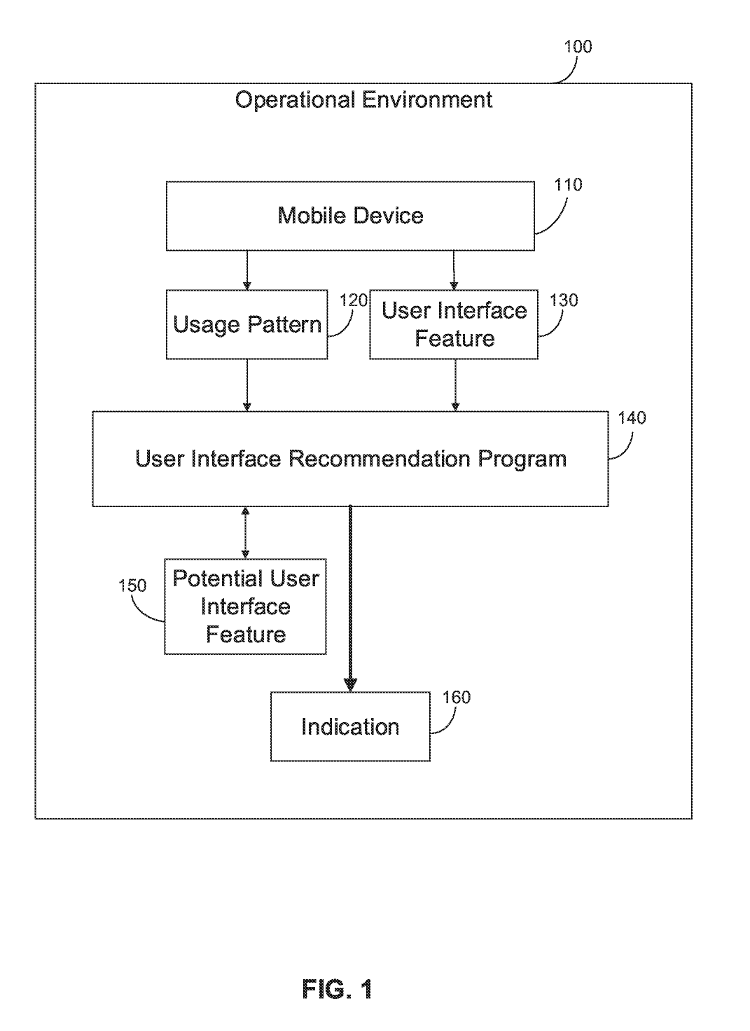

Referring now to the invention in more detail, FIG. 1 is a block diagram displaying an exemplary operational environment suitable for operation of at least one embodiment of the invention, generally designated an operational environment 100. The operational environment 100 includes a mobile device 110, a usage pattern 120, a user interface feature 130, a user interface recommendation program 140, a potential user interface feature 150, and an indication 160 all in mutual communication and interconnected via the operational environment 100. The operational environment 100 may be a cloud-based, virtual, or distributed environment, a remote environment on defined server hardware, or, more generally, the operational environment 100 may be any type of environment suitable for access by the user interface recommendation program 140.

The mobile device 110 may be a mobile phone, smart phone, tablet, laptop, or personal computer. The mobile device 110 is capable of responding to input from a user. The mobile device 110 may receive input from a user via the user interface feature 130. In some embodiments the mobile device 110 is a general computing system and/or computing device.

The user interface feature 130 connects a user to the mobile device 110 via an interface. The user interface feature 130 enables a user to communicate and use the mobile device 110. The mobile device 110 may have multiple user interface features similar to the user interface feature 130. The user interface feature 130 may be a device selected from a group consisting of: a touchscreen, a non-touch sensitive display (such as a voice recognition or eye movement recognition display), a mechanical button, multiple mechanical buttons, a physical keyboard, a soft keyboard, a handwriting interface, an external human interface device (such as an external mouse, a trackball, a trackpad, touchpad, or braille typewriter), a global positioning system receiver, an accelerometer, a capacitive button, a mechanical button, a camera, a microphone, a temperature sensor, a scent sensor, a scent emitter, a speaker, a light emitting device, a light sensor, a wireless network interface, and a cellular network sensor. The user interface feature 130 may utilize multiple user interface features of the mobile device 110. The user interface feature 130 may be enabled with a mobile device update or after a user downloads a mobile device application.

The mobile device 110 is capable of tracking and storing user activity as the usage pattern 120. The usage pattern 120 may be a usage history such as activities a user performed via the mobile device 110. The usage pattern 120 may include timestamp data, location data, and other metadata about how the mobile device 110 was used. The usage pattern 120 may include what user interface features, such as the user interface feature 130, were used to perform various activities. For example, the usage pattern 120 may include that phone calls were dialed using a soft keyboard. The usage pattern 120 may include a list of mobile device applications that were used in association with specific user interface features, such as the user interface feature 130. For example, the usage pattern 120 may include that a social media application is used after a camera is used.

The user interface recommendation program 140 is capable of receiving the usage pattern 120 and the user interface feature 130 via the operational environment 100 as input, generating the potential user interface feature 150 as intermediate output, and generating the indication 160 as output. The user interface recommendation program 140 may be a dedicated client computing device. The user interface recommendation program 140 may be an analytics engine.

The potential user interface feature 150 is a user interface feature similar to the user interface feature 130. The potential user interface feature 150 may be selected, by the user interface recommendation program 140, from a group of user interface features, such as the user interface feature 130. The potential user interface feature 150 may be selected based on the usage pattern 120.

The indication 160 is generated by the user interface recommendation program 140 as output. The indication 160 may be an alert, notification, or other means of presenting. The indication 160 includes information about the user interface feature 130. The indication 160 may include instructions to use the user interface feature 130.

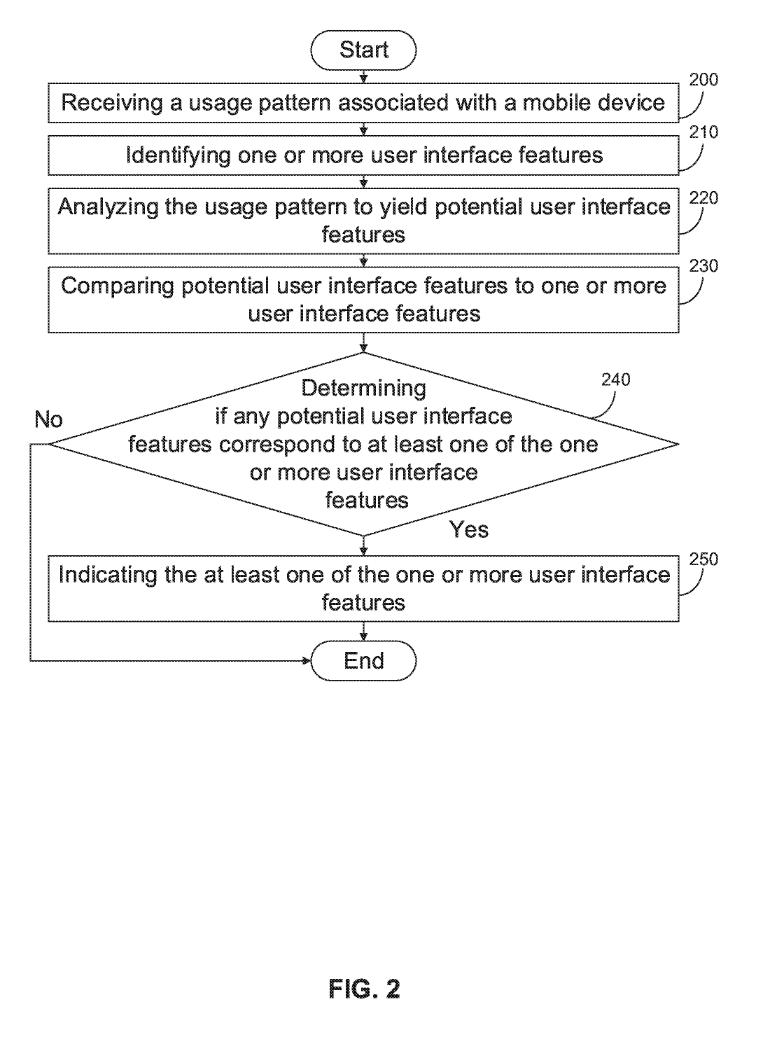

FIG. 2 is a flowchart depicting the operational steps of the user interface recommendation program 140, executing within the operational environment 100 of FIG. 1, in accordance with an embodiment of the present invention.

At step 200, the user interface recommendation program 140 receives the usage pattern 120. Receiving may include a user explicitly calling the user interface recommendation program 140 from a command line interface using a reference to the usage pattern 120 as an argument. Alternatively, receiving may include automated calls to the user interface recommendation program 140, for example, from an integrated development environment or as part of a user interface recommendation program management system.

At step 210 the user interface recommendation program 140 identifies one or more user interface features similar to the user interface feature 130. The user interface features identified at step 210 are included in the usage pattern 120 below a threshold. In some embodiments, the threshold is zero. In such an embodiment, the user interface recommendation program 140 identifies user interface features that are not included in the usage pattern 120. For example, if the user interface feature of a voice recognition display does not appear as a part of the usage pattern 120, the user interface recommendation program 140 identifies the user interface feature of a voice recognition display at step 210.

At step 220 the user interface recommendation program 140 analyzes the usage pattern 120 to yield the potential user interface features. Analyzing may include organizing activity within the usage pattern 120 and comparing activity to the user interface features identified at step 210. In some embodiments, the user interface feature 130 may be enabled for use in a particular context. The particular context may be a mobile device application. For example, a camera is enabled for use in a photography application and shortcuts and other user interface features associated with the camera are also enabled for use in a photography application. Analyzing may be based on identifying contexts within the usage pattern 120, such as a type of application frequently used, and seeing if contexts for the user interface features identified at step 210 correspond to the contexts. Contexts for a user interface feature may be predetermined and/or determined dynamically based on usage patterns for the mobile device 110 and mobile devices similar to the mobile device 110. At step 220, the user interface recommendation program 140 generates the potential user interface feature 150 as intermediate output.

At step 230 the user interface recommendation program 140 compares the potential user interface feature 150 that was yielded at step 220 to the user interface features identified at step 210.

At step 240 the user interface recommendation program 140 determines if any of the potential user interface features yielded at step 220 correspond to the user interface features identified at step 210. If yes, at least one of the potential user interface features yielded at step 220 corresponds to the user interface feature identified at step 210, the user interface recommendation program 140 proceeds to step 250. If no, the user interface recommendation program 140 exits.

At step 250 the user interface recommendation program 140 indicates the user interface features that corresponds to a potential user interface feature. This indication may be the indication 160. Indicating may include displaying the user interface feature 130 via the mobile device 110. Indicating may include displaying instructions to use the user interface feature 130 via the mobile device 110. Indicating may include sending a notification, alert, or alarm to the mobile device or another computing device capable to communicating with the user interface recommendation program 140 via the operational environment 100.

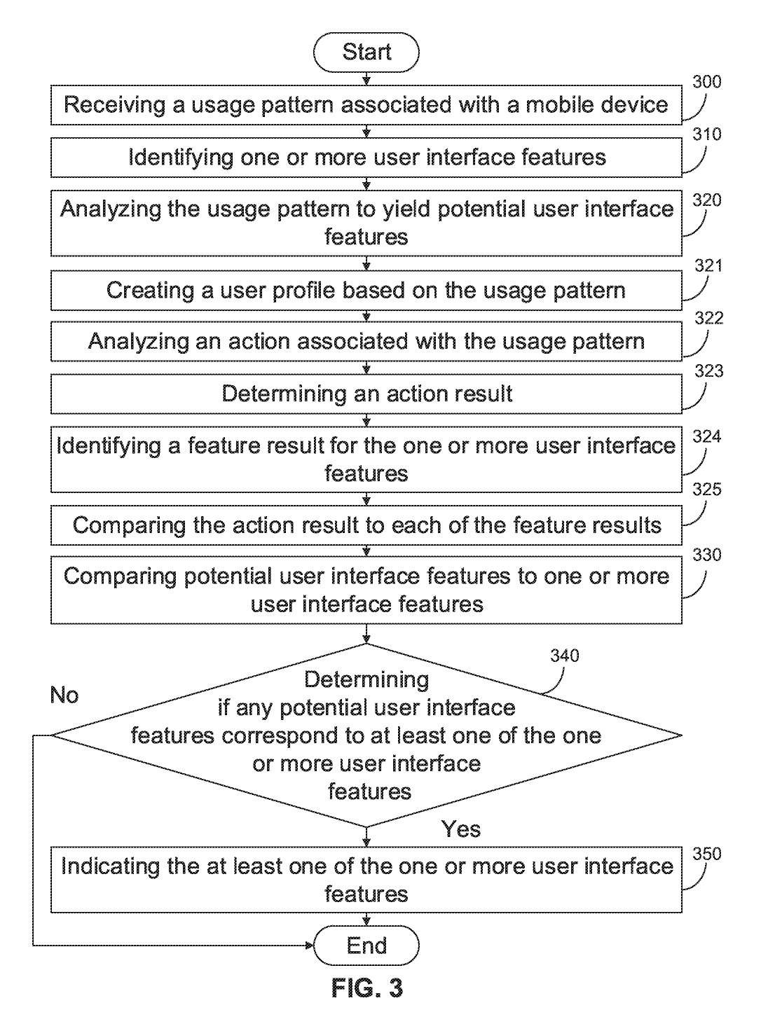

FIG. 3 is a flowchart depicting operational steps for a user interface recommendation program in accordance with at least one embodiment of the present invention where the user interface recommendation program creates a user profile.

The user interface recommendation program 140 performs step 300, step 310, step 330, step 340, and step 350 similar to step 200, 210, step 230, step 240, and step 250.

At step 320 the user interface recommendation program 140 analyzes the usage pattern 120 to yield the potential user interface feature 150. The user interface recommendation program 140 performs step 320 in a manner similar to step 220 and including step 321, 322, 323, 324, and 325.

At step 321 the user interface recommendation program 140 creates a user profile based on the usage pattern 120. The user profile may include information about a particular user of the mobile device 110. For example, the user profile may include information about the particular user's age and any assistance the user may need when operating the mobile device 110. The user profile will collect and organize actions taken by the user.

At step 322 the user interface recommendation program 140 analyzes an action associated with the usage pattern 120 and the user profile. For example, an action may be pressing a series of numbers on a soft keypad. An action may include oscillating between a mobile web browser displaying a phone number and a soft keypad for a phone calling application. Analyzing may be based on predetermined rules associated with actions. Analyzing may be based on grouping activity together based on time proximity. For example, a collection of user activity may be grouped together as a part of a single action if the collection of user activity occurs within a certain timeframe or occurs at a similar location or uses a common mobile application.

At step 323 the user interface recommendation program 140 determines an action result. The action result may be based on predetermined rules. The action result may be a final user activity in the collection of user activities. For example, if several user actions are taken before a phone call is made, and after the phone call is completed the user stops using the mobile device 110 for several minutes, the user interface recommendation program 140 may determine that the phone call was the action result.

At step 324 the user interface recommendation program 140 identifies a feature result for each of the user interface feature 130. The feature results are similar to action results identified at step 323. The feature result may be predetermined by a user.

At step 325 the user interface recommendation program 140 compares the action results to the feature results. The user interface recommendation program 140 identifies if reasons for using the potential user interface feature 150 are similar to actions the user has taken. For example, if a feature result is to make a phone call and the usage pattern 120 and user profile indicate the user makes phone calls, the user interface recommendation program 140 will identify that user interface feature that will allow a user to make phone calls as a potential user interface feature.

In some embodiments the user interface recommendation program 140 may identify a best time for a user to use a specific application. For example, a mobile device may include a web-browser interface for a social media application and a dedicated social media application. The usage pattern 120 may indicate that each time a user is unable to access the web-browser interface for the social media application at 9am the user is unsuccessful and fails to access the social media application. In such an embodiment, the user interface recommendation program 140 may generate an indication, such as the indication 160, alerting the user to access the social media application via the dedicated social media application at 9am. In some embodiments the user interface recommendation program 140 may continue to monitor whether or not an operation, such as accessing the web-browser interface, is successful to determine if there are patterns in efficiency. In some embodiments, the user interface recommendation program 140 may identify an operation that has been performed and cataloged via the usage pattern 120. The user interface recommendation program 140 may determine whether the operation has been successful and if any external factors influence whether or not the operation is successful, such as time of day, wireless network access, or location. The user interface recommendation program 140 may generate an indication, recommendation, or instruction for further monitoring if the user interface recommendation program 140 determines the operation has not been successful.

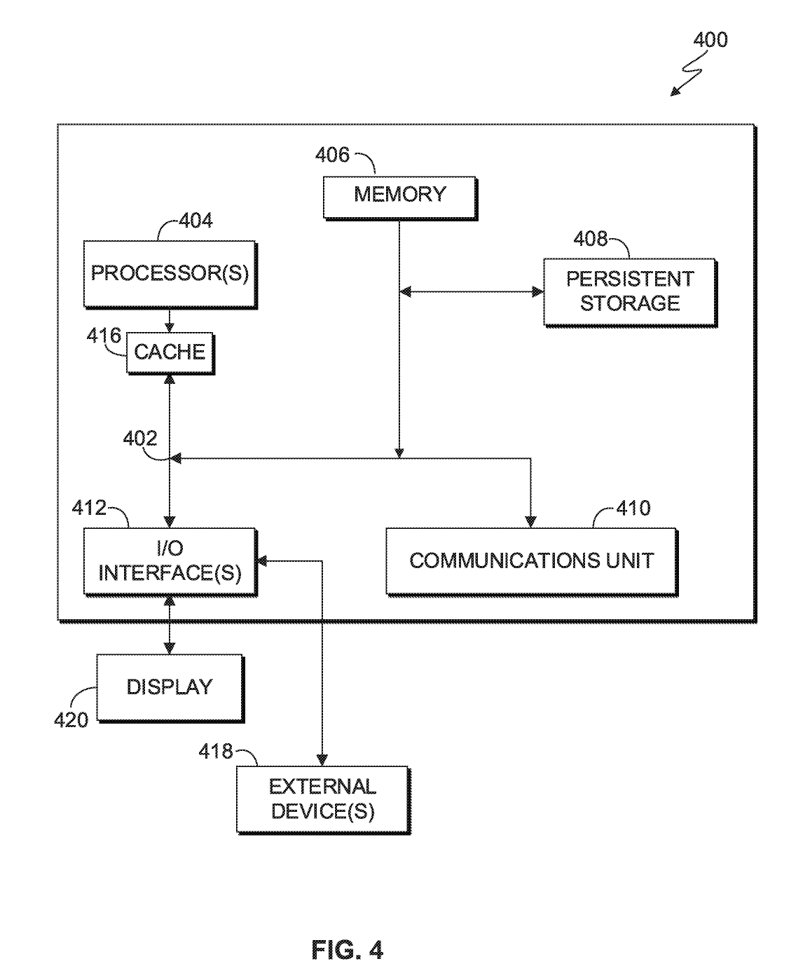

FIG. 4 is a block diagram depicting components of a computer 400 suitable for executing the user interface recommendation program 140. FIG. 4 displays the computer 400, the one or more processor(s) 404 (including one or more computer processors), the communications fabric 402, the memory 406, the RAM 416, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g., microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for the user interface recommendation program 140 may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. The user interface recommendation program 140 may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving a usage pattern, said usage pattern being associated with a mobile device;
identifying one or more user interface features, said one or more user interface features being for said mobile device, said one or more user interface features being at most included below a threshold extent in said usage pattern;
analyzing said usage pattern to yield potential user interface features;
comparing said usage pattern user interface features to said one or more user interface features; and
responsive to at least one of said one or more user interface features corresponding to any of said potential user interface features, indicating said at least one of said one or more user interface features.

2. The computer-implemented method of claim 1 wherein said one or more user interface features comprises at least one device selected from a group consisting of:
(a) a touchscreen;
(b) a non-touch sensitive display;
(c) one or more mechanical buttons;
(d) one or more capacitive buttons;
(e) a physical keyboard;
(f) a soft keyboard;
(g) handwriting interface;
(h) an external human interface device;
(i) a global positioning system receiver;
(j) an accelerometer;
(k) a camera;
(l) a microphone;
(m) a temperature sensor;
(n) a scent sensor;
(o) a scent emitter;
(p) a speaker;
(q) a light emitting device;
(r) a light sensor;
(s) a wireless network interface; and
(t) a cellular network sensor.

3. The computer-implemented method of claim 1 further comprising:
identifying an operation, said operation being associated with said mobile device, said operation being included in said usage pattern;
analyzing said usage pattern to determine whether said operation has been unsuccessful; and
responsive to said operation having been unsuccessful, generating an indication.

4. The computer-implemented method of claim 1 wherein each of said one or more user interface features and each of said one or more usage pattern features is enabled for at least one context.

5. The computer-implemented method of claim 4 wherein comparing said usage pattern user interface features to said one or more user interface features is based on said at least one context.

6. The computer-implemented method of claim 4 wherein said at least one context is a mobile device application.

7. The computer-implemented method of claim 1 wherein analyzing said usage pattern to yield potential user interface features comprises:
creating a user profile, said user profile tracking activity based on said usage pattern;
analyzing an action associated with said usage pattern;
determining an action result, said action result being a purpose for said action;
identifying a feature result for each of said one or more user interface features; and
comparing said action result to each of said feature results.

8. A computer program product comprising:
one or more computer readable storage media and program instructions stored on said one or more computer readable storage media, said program instructions comprising instructions to:
receive a usage pattern, said usage pattern being associated with a mobile device;
identify one or more user interface features, said one or more user interface features being for said mobile device, said one or more user interface features being at most included below a threshold extent in said usage pattern;
analyze said usage pattern to yield potential user interface features;
compare said usage pattern user interface features to said one or more user interface features; and
responsive to at least one of said one or more user interface features corresponding to any of said potential user interface features, indicate said at least one of said one or more user interface features.

9. The computer program product of claim 8 wherein said one or more user interface features comprises at least one device selected from a group consisting of:
(a) a touchscreen;
(b) a non-touch sensitive display;
(c) one or more mechanical buttons;
(d) one or more capacitive buttons;
(e) a physical keyboard;
(f) a soft keyboard;
(g) handwriting interface;
(h) an external human interface device;
(i) a global positioning system receiver;
(j) an accelerometer;
(k) a camera;
(l) a microphone;
(m) a temperature sensor;
(n) a scent sensor;
(o) a scent emitter;
(p) a speaker;
(q) a light emitting device;
(r) a light sensor;
(s) a wireless network interface; and
(t) a cellular network sensor.

10. The computer program product of claim 8, further comprising instructions to:
identify an operation, said operation being associated with said mobile device, said operation being included in said usage pattern;
analyze said usage pattern to determine whether said operation has been unsuccessful; and
responsive to said operation having been unsuccessful, generate an indication.

11. The computer program product of claim 8 wherein each of said one or more user interface features and each of said one or more usage pattern features is enabled for at least one context.

12. The computer program product of claim 11 wherein instructions to compare said usage pattern user interface features to said one or more user interface features is based on said at least one context.

13. The computer program product of claim 11 wherein said at least one context is a mobile device application.

14. The computer program product claim 8 wherein instructions to analyze said usage pattern to yield potential user interface features comprises instructions to:
create a user profile, said user profile tracking activity based on said usage pattern;
analyze an action associated with said usage pattern;
determine an action result, said action result being a purpose for said action;
identify a feature result for each of said one or more user interface features; and
compare said action result to each of said feature results.

15. A computer system comprising:
one or more computer processors;
one or more computer readable storage media;
computer program instructions; and
said computer program instructions being stored on said computer readable storage media for execution by at least one of said one or more processors, said computer program instructions comprising instructions to:
receive a usage pattern, said usage pattern being associated with a mobile device;
identify one or more user interface features, said one or more user interface features being for said mobile device, said one or more user interface features being at most included below a threshold extent in said usage pattern;
analyze said usage pattern to yield potential user interface features;
compare said usage pattern user interface features to said one or more user interface features; and
responsive to at least one of said one or more user interface features corresponding to any of said potential user interface features, indicate said at least one of said one or more user interface features.

16. The computer system of claim 15 wherein said one or more user interface features comprises at least one device selected from a group consisting of:
(a) a touchscreen;
(b) a non-touch sensitive display;
(c) one or more mechanical buttons;
(d) one or more capacitive buttons;
(e) a physical keyboard;
(f) a soft keyboard;
(g) handwriting interface;
(h) an external human interface device;
(i) a global positioning system receiver;
(j) an accelerometer;
(k) a camera;
(l) a microphone;
(m) a temperature sensor;
(n) a scent sensor;
(o) a scent emitter;
(p) a speaker;
(q) a light emitting device;
(r) a light sensor;
(s) a wireless network interface; and
(t) a cellular network sensor.

17. The computer system of claim 15, further comprising instructions to:
identify an operation, said operation being associated with said mobile device, said operation being included in said usage pattern;
analyze said usage pattern to determine whether said operation has been unsuccessful; and
responsive to said operation having been unsuccessful, generate an indication.

18. The computer system of claim 15 wherein each of said one or more user interface features and each of said one or more usage pattern features is enabled for at least one context.

19. The computer system of claim 18 wherein instructions to compare said usage pattern user interface features to said one or more user interface features is based on said at least one context.

20. The computer system of claim 18 wherein said at least one context is a mobile device application.
